(19) United States
(12) Patent Application Publication
(10) Pub. No.: US 2002/0064621 A1
(43) Pub. Date: May 30, 2002

(54) Placemat with conformal, integral drink coaster

(76) Inventor: Angela Marcela Wilkinson, Austin, TX (US)

Correspondence Address: Docket Clerk, P.O. Drawer 800889, Dallas, TX, 75380, US

(21) Appl. No.: 10/055,358

(22) Filed: Jan. 22, 2002

Related U.S. Application Data
(63) Continuation-in-part of application No. 29/147,813, filed on Sep. 5, 2001.
Application No. 29/147,813 is a division of application No. 29/110,347, filed on Sep. 7, 1999.

(51) Int. Cl. B32B 3/02

(52) U.S. Cl. 428/81

(57) ABSTRACT

Placemats include a major portion sized not substantially larger than necessary to accommodate a place setting, and include an integrally formed coaster extension sized, with any overlap to the major portion, to accommodate a beverage container. Undue use of available space by the placemat is therefore avoided while the underlying surface is protected from condensation or spillage from beverage containers. Thematic content conveyed by the shape and/or graphics of the major portion and coaster extension are consistent or complementary to provide a unified conceptual appearance.

### CROSS-REFERENCE TO RELATED APPLICATIONS

This application is related to and claims priority as a continuation-in-part of U.S. Design patent application Ser. No. 29/147,813 entitled COMBINED PLACEMAT AND COASTER and filed Sep. 5, 2001, which is a divisional of U.S. Design patent application No. 29/110,347 also entitled COMBINED PLACEMAT AND COASTER and filed Sep. 7, 1999, now U.S. Pat. No. D448,232 issued Sep. 25, 2001. The content of the above-identified applications is hereby incorporated by reference.

### TECHNICAL FIELD OF THE INVENTION

The present invention is directed, in general, to placemats for table settings and, more specifically, to designs for placemats including thematic content such as holiday designs and the like.

### BACKGROUND OF THE INVENTION

Placemats are commonly employed in many households to protect a dining table or tablecloth from damage during meals, particularly in households having children. Such damage may result, for instance, from food or drink spillage or droppings, condensation from cold drinks, and the like. Placemats under the plate and beverage container protect the underlying surface from damage of this type.

Conventional placemats, however, are generally sized and designed based on the plate and utensils (including, perhaps, a napkin), without consideration of the beverage container. However, condensation or spillage from a cold beverage container, or spillage from a hot beverage container, may significantly damage or stain many table surfaces and most tablecloths.

One obvious solution is to simply make the overall size of the placemats sufficiently large to accommodate a beverage container. However, the requisite overall sizes for such accommodation of a beverage container will often preclude fitting the placemat into limited-area spaces and/or reduce the space available for other uses such as placement of serving dishes containing food, condiment (e.g., salt and pepper shakers), or decorative center-pieces.

There is, therefore, a need in the art for an improved placemat design accommodating beverage containers without unnecessary increases in the overall, general size of the placemat.

### SUMMARY OF THE INVENTION

To address the above-discussed deficiencies of the prior art, it is a primary object of the present invention to provide, for use as a placemat, a major portion sized not substantially larger than necessary to accommodate a place setting and an integrally formed coaster extension sized, with any overlap to the major portion, to accommodate a beverage container. Undue use of available space by the placemat is therefore avoided while the underlying surface is protected from condensation or spillage from beverage containers. Thematic content conveyed by the shape and/or graphics of the major portion and coaster extension is consistent or complementary to provide a unified conceptual appearance. The coaster extension may be fabricated to be removable, having an interlocking shape in common with a peripheral region of the major portion.

The foregoing has outlined rather broadly the features and technical advantages of the present invention so that those skilled in the art may better understand the detailed description of the invention that follows. Additional features and advantages of the invention will be described hereinafter that form the subject of the claims of the invention. Those skilled in the art will appreciate that the conception and the specific embodiment disclosed may be readily used as a basis for modifying or designing other structures for carrying out the same purposes of the present invention. Those skilled in the art will also realize that such equivalent constructions do not depart from the broadest form of the spirit and scope of the invention.

Before undertaking the DETAILED DESCRIPTION OF THE INVENTION below, it may be advantageous to set forth definitions of certain words or phrases used throughout this patent document: the terms “include” and “comprise,” as well as derivatives thereof, mean inclusion without limitation; the term “or” is inclusive, meaning and/or; and the phrases “associated with,” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. Definitions for certain words and phrases are provided throughout this patent document, and those of ordinary skill in the art will understand that such definitions apply in many, if not most, instances to prior as well as future uses of such defined words and phrases.

### BRIEF DESCRIPTION OF THE DRAWINGS

For a more complete understanding of the present invention, and the advantages thereof, reference is now made to the following descriptions taken in conjunction with the accompanying drawings, wherein like numbers designate like objects, and in which:

FIGS. 1A through 1D depict plan views of the general shape and configuration of a generically-shaped placemat each having a conformal, integral drink coaster according to one embodiment of the present invention; and

FIGS. 2A through 2P depict plan views of the shape or configuration and design patterns of various examples of thematic placemats each having a conformal, integral drink coaster according to one embodiment of the present invention.

### DETAILED DESCRIPTION OF THE INVENTION

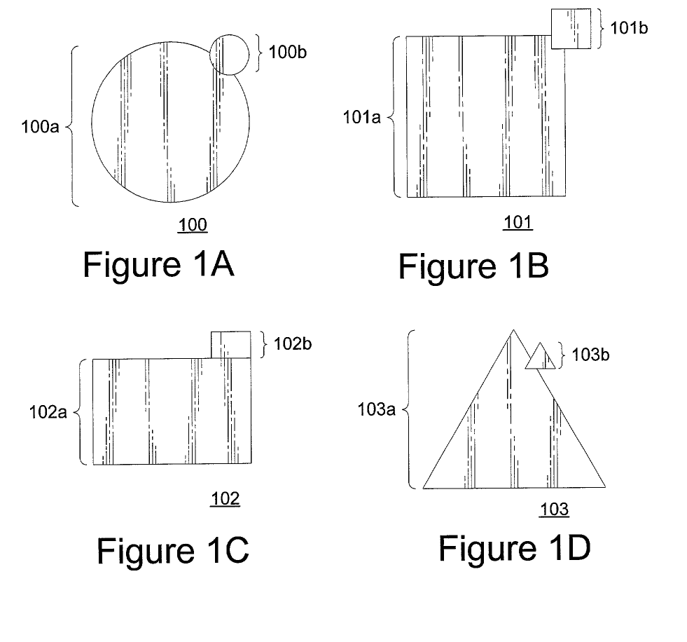

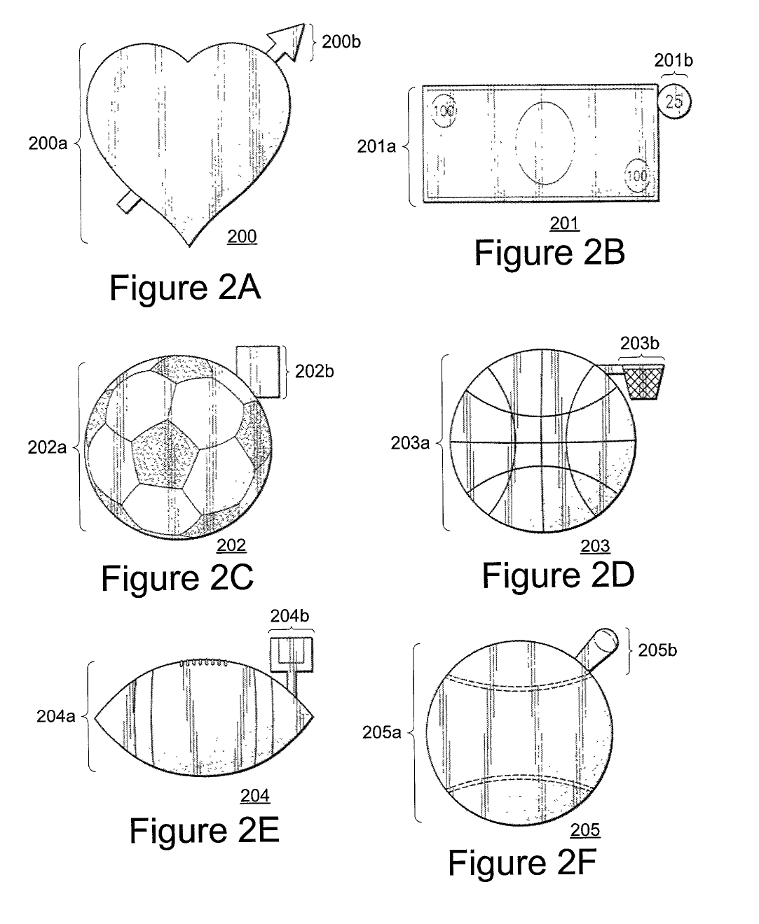

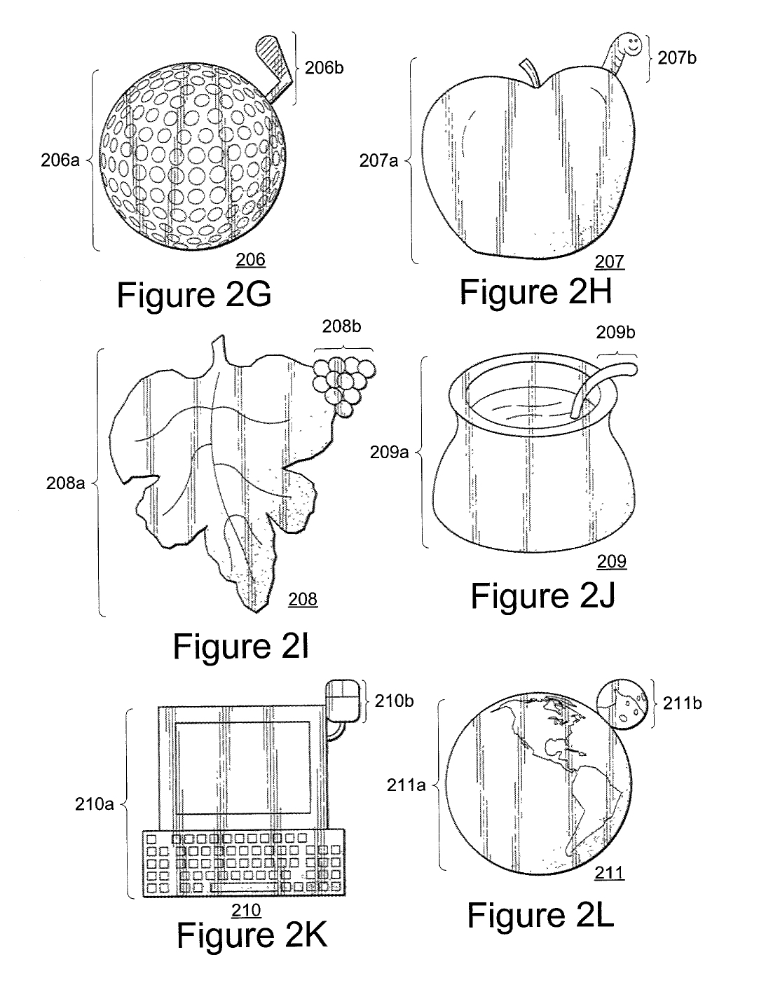

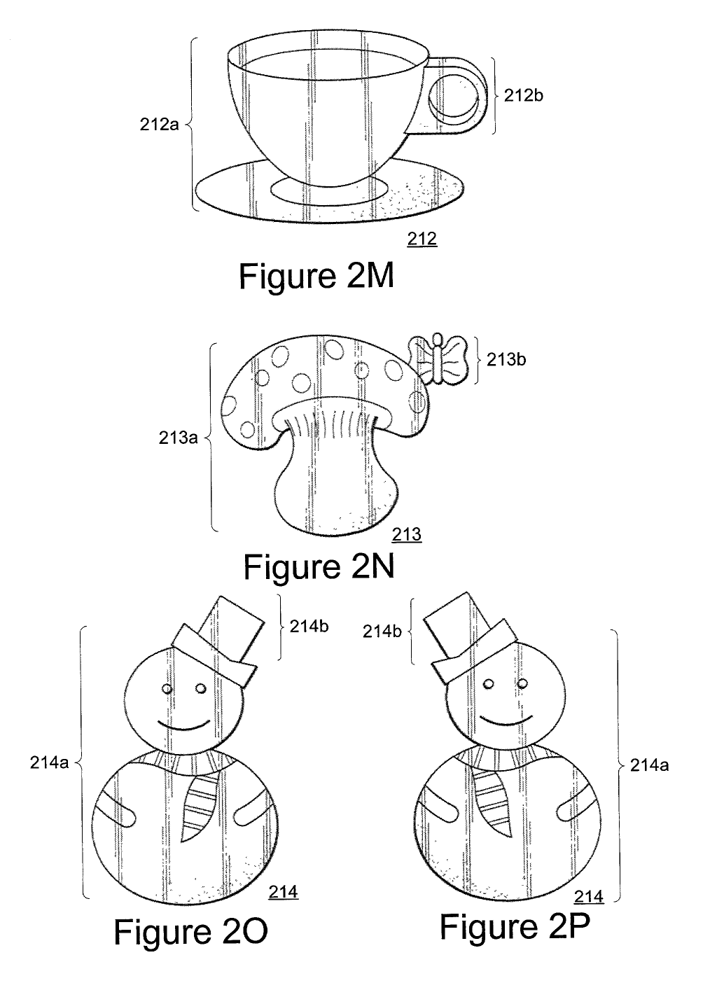

FIGS. 1A-1D and 2A-2P, discussed below, and the various embodiments used to describe the principles of the present invention in this patent document are by way of illustration only and should not be construed in any way to limit the scope of the invention. Those skilled in the art will understand that the principles of the present invention may be implemented in any suitably arranged device.

Each of the designs depicted in the figures and described below may be formed in the same manner utilized for forming conventional placemats and of the same materials (e.g., cloth, laminate, cork, rubber, neoprene and other plastics, etc.). Those skilled in the art will recognize that various surface coatings and the like may be suitably employed, and colorants for graphic content in thematic placemats may be applied in any suitable manner known in the art.

FIGS. 1A through 1D depict plan views of the general shape or configuration of generically-shaped placemats each having a conformal, integral drink coaster according to one embodiment of the present invention. Each placemat 100-103 includes a major portion 100a-103a having a generally identifiable shape (circular, square, rectangular and triangular in the examples shown).

The sizing of such major portions 100a-103a is selected to accommodate only a typical place setting—that is, a plate, and optionally also silverware (fork, spoon and knife) and/or napkin. Most dinner plates are less than approximately 10-12 inches in diameter, most silverware has a maximum width of less than about 2 inches, and typical napkins, when folded and placed under the silverware or rolled in a napkin ring, require less than about 2-3 inches of additional space over the silverware. Accordingly, an overall dimension of perhaps 12-14 inches in height by 18-24 inches in width is all that is required the major portion 100a-103a of placemats 100-103. Such sizes generally will not easily also accommodate a beverage container.

In accordance with the present invention, therefore, each placemat also includes an integrally formed extension 100b-103b projecting from a peripheral edge of the respective major portion 100a-103a and serving as a coaster. The extension 100b-103b is sized to accommodate typical beverage container (glasses, tumblers, mugs, coffee cups, soft drink cans, etc.), which are generally no large than about 3-4 inches in diameters at the base. Each extension 100b-103b may extend from any peripheral edge of the associated major portion 100a-103b, but preferably extends from the upper, right, or upper-right edge of the placemat for the convenience of predominantly right-handed diners. (For reversible placemats such as those described below, projection of the coaster extension from the upper-right corner of the major portion allows the placemat to simply be flipped over for the convenience of left-handed diners).

The extensions 100b-103b of placemats 100-103 preferably have a shape consistent with the shape of the associated major portion 100a-103a. As shown, the shapes of extensions 100b-103b and major portions 100a-103a either may be contiguous (e.g., FIG. 1C) or may somewhat overlap (e.g., FIGS. 1A-1B and 1D), so long as sufficient area is provided by the overlapping and non-overlapping portions of the extensions 100b-103b to accommodate a beverage container, functioning as a coaster.

FIGS. 2A through 2P depict plan views of the shape or configuration and design patterns of various examples of thematic placemats each having a conformal, integral drink coaster according to one embodiment of the present invention. As with the examples of FIGS. 1A-1D, each placemat 200-214 includes a major portion 200a-214a nominally sized to accommodate a place setting (and preferably not substantially larger) and an integrally formed coaster extension 200b-214b sized (including any overlapping portions) to accommodate a beverage container.

In the embodiments of FIGS. 2A-2P, however, placemats 200-214 each have a shape patterned after or depicting an identifiable object, and preferably also have related graphic content depicting features of the object. Placemat 200 in FIG. 2A, for instance, has a heart shape, while placemat 201 in FIG. 2B has the shape of a United States currency bill (any denomination) together with graphic content depicting features of a currency bill.

Coaster extensions 200b-214b preferably have a shape and graphic content, if any, consistent with whatever theme or subject matter conveyed by the shape and/or graphic content of the associated major portion 200a-214a. Thus, for instance, coaster extension 200b for placemat 200 in FIG. 2A has the shape of an arrowhead for an arrow through the heart shape of major portion 200a, while coaster extension 201b in FIG. 2B has the shape of a United States currency coin. The coaster extensions and the associated major portion have consistent and/or complementary thematic content conveyed by the shape or graphics.

FIGS. 2C through 2G are examples of sports-themed placemats 202-206 according to the present invention. The shape and graphic content of placemat 202 includes a soocer ball major portion 202a and a net coaster extension 202b; for placemat 203, a basketball major portion 203a and 185 basketball rim and net 203b; for placemat 204, a football shaped major portion 204a is accompanied by a field goal shaped coaster extension 204b; the baseball major portion 205a of placemat 205 has a partial bat coaster extension 205b; and golf ball major portion 206a of placemat 206 has a partial golf club coaster extension 206b.

Further examples are illustrated in FIGS. 2H through 2P. Apple major portion 207a and partial worm coaster extension 207b make up placemat 207. Grape leaf major portion 208a and small grape bunch coaster extension 208b comprise placemat 208. Pot-of-gold major portion 209a and rainbow 209b form placemat 209. Computer 210a and mouse 210b form placemat 210, while earth 211a and moon 211b form placemat 211. Saucer and teacup 212a with handle 212b form placemat 212, mushroom 213a and butterfly 213b form placemat 213, and snowman 214a with hat 214b form placemat 214. Placemats 212 and 214 depicted in FIGS. 2M and 2O (and 2P), respectively, illustrate that the coaster extension need not be a separate item from the identifiable object depicted by the major portion, but may instead merely be a component portion of that object which extends out from the remainder.

The graphic content applied to the surface of the placemat is preferably duplicated, in mirror image, on the opposite side, so that both sides of the placemat display the same image except for orientation. In this manner, the placemat becomes reversible, with either side being suitable for use. Therefore, if the coaster extension is positioned to project from the upper right region of the major portion for the convenience of predominantly right-handed diners, the placemat may be simply flipped over as illustrated by FIG. 2P.

The coaster extension need not necessarily be integrally formed with the major portion of the placemat in the present invention, but may be a separate piece which is attached by sewing (for cloth placemats), gluing or otherwise securing the coaster extension to the major portion. Moreover, the coaster extension need not be permanently affixed to the major portion; instead, the coaster extension may have a protrusion shaped to interlock with a cut-out from a peripheral edge of the major portion in the manner of jigsaw puzzle pieces. In this fashion, the coaster extension may be separated from the major portion for cleaning, storage, and the like, then reattached to the major portion at a later time.

Although the present invention has been described in detail, those skilled in the art will understand that various changes, substitutions, variations, enhancements, nuances, gradations, lesser forms, alterations, revisions, improvements and knock-offs of the invention disclosed herein may be made without departing from the spirit and scope of the invention in its broadest form.

What is claimed is:

1. A placemat, comprising:
a major portion sized to completely underlie a place setting; and
a coaster extension projecting from a peripheral edge of the major portion and sized to completely underlie a beverage container.

2. The placemat as set forth in claim 1, wherein the size of the major portion is not substantially larger than necessary to completely underlie a place setting.

3. The placemat as set forth in claim 1, wherein the coaster extension is integrally formed with the major portion.

4. The placemat as set forth in claim 1, wherein a shape of the coaster extension is consistent with a theme conveyed by a shape of the major portion.

5. The placemat as set forth in claim 1, wherein any graphic content on the coaster extension is consistent with a theme conveyed by graphic content on the major portion.
